(19) United States
(12) Patent Application Publication
(10) Pub. No.: US 2002/0062351 A1
(43) Pub. Date: May 23, 2002

(54) Information providing apparatus, information processing apparatus, and information recording medium

(76) Inventor: Mitsuteru Oshima, Kyoto (JP)

Correspondence Address: BANNER & WITCOFF, 1001 G STREET N W, SUITE 1100, WASHINGTON, DC, 20001, US

(21) Appl. No.: 09/986,382

(22) Filed: Nov. 8, 2001

(30) Foreign Application Priority Data
Nov. 22, 2000 (JP) 2000-356563

(51) Int. Cl. G06F 15/16

(52) U.S. Cl. 709/206; 379/259

(57) ABSTRACT

An information providing apparatus for providing an information receiver with an information providing service is provided, including: information accumulating means for accumulating information to be provided; electronic mail receiving means for receiving an electronic mail; and information providing control means for extracting desired information from the information accumulating means to start the information providing service for the information receiver having transmitted the electronic mail upon receipt of the electronic mail by the electronic mail receiving means.

### BACKGROUND OF THE INVENTION

1. Field of the Invention

The present invention relates to information providing services using communication means.

2. Description of the Related Art

Recently, there arise increasing services that provide various types of information such as results of sports games via personal computers, internet-accessible cellular phones, or the like. Examples of such information providing services include: running a bulletin of information on a web page by an information provider; transmitting an e-mail containing information directly to an information receiver; and distributing a menu screen for providing information to an apparatus, such as a cellular phone, owned by an information receiver.

An information receiver who wishes to obtain such an information providing service may sometimes be required to follow a registration procedure before utilizing the service by the information provider. In the registration procedure the information receiver inputs his or her own personal information identifying the receiver such as name, telephone number or e-mail address before the information provider gives an ID number or a password to the information receiver. When such a procedure has been completed, the information receiver can enjoy the information providing service.

The information receiver who wishes to be continuously provided with information inputs the ID number or the password given in the registration procedure to log in to the second or subsequent information providing service.

The information provider draws up a list of persons by collecting personal information of information receivers registered or performs advertising activities or the like as its own activities by transmitting advertisements or the like desired to be transmitted from the information provider side to information receivers through e-mail or telephone with use of such a list of persons.

Such a conventional information providing service system requires an information receiver to input various personal information when the information receiver wishes to be provided with information for the first time and to input the ID number or the password each time the information receivers wishes to obtain the second or subsequent service. Thus, the information receiver must follow various complex and cumbersome procedures to obtain desired information from the information provider. Further, the information receiver has to make some effort to write down the ID number and the password on a notebook or the like. If such a notebook is lost, the information receiver may have to follow the registration procedure again from the beginning.

Even if information is provided on a web page that is in a state freely accessible from the information receiver, the information receiver must input a URL every time before obtaining the information providing service.

Recently, an increasing number of information receivers wish to be provided with information through portable terminals such as cellular phones. Such a cellular phone has a small input means such as a keyboard or pushbuttons, which makes difficult the inputting of the URL, ID number, password or the like. Thus, such an information receiver has to perform more cumbersome and difficult operations.

Consequently, the information receiver feels it cumbersome to follow such complicated procedures and hence is discouraged from utilizing such an information providing service. As a result, the number of users of information providing services does not increase as desired.

On the other hand, the information provider, whose main object is to collect personal information, experiences many troubles in which the object cannot be attained due to wrong information such as wrong telephone numbers or e-mail addresses erroneously or intentionally input by the information receiver in the registration procedure.

Additionally, a large amount of fee must be paid to the menu administrator such as a cellular phone company in order for an information providing service menu to run constantly on the terminals owned by information receivers.

Accordingly, it is an object of the present invention to realize a convenient and inexpensive information providing service which overcomes all the foregoing problems essential to the prior art.

### SUMMARY OF THE INVENTION

According to the present invention, there is provided an information providing apparatus for use in providing an information receiver with an information providing service, the apparatus being configured to cause the information providing service to start upon receipt of an e-mail or a telephone dial signal for an information receiver who is the transmitter identified by the e-mail or the telephone dial signal transmitted.

Such an apparatus configured to cause the information providing service to start upon receipt of an e-mail or a dial telephone signal serving as a cue allows the information receiver to utilize the information providing service easily without requiring the information receiver to follow cumbersome registration procedure or other procedures including inputting of a URL, ID number, password or the like.

With this apparatus, the cost including the fee for running an information providing menu is no more necessary.

Further, the information provider becomes capable of collecting exact e-mail addresses or telephone numbers as personal information in exchange for the provision of information.

Particularly where the apparatus is configured to cause the information providing service to start upon receipt of a telephone signal serving as a cue, the information receiver can save the effort to input the e-mail address of the information provider. Further, the information receiver can utilize the information providing service more conveniently through an easy operation such as to give a telephone call even if the information receiver is unfamiliar with transmission or receipt of e-mails.

In a specific embodiment of the invention the information providing apparatus is configured to cause the information providing service to start and stop upon receipts of respective e-mails from the information receiver which are used as cues for the start and stop, respectively, of the information providing service.

This configuration allows the information providing service to start in response to a simpler and to stop by a simpler procedure consisting of simply transmitting an e-mail. Thus, the information providing service becomes more convenient as a whole.

If information is provided in the form of, for example, an e-mail, the information receiver can enjoy the information providing service rendered more convenient and less expensive.

In the case where information is provided on a home page to be read by the information receiver, the information receiver is required to confirm whether the contents of information have been updated or not through the communication line constantly kept on every time the information receiver wishes to obtain the latest information.

With the configuration for providing information in the form of an e-mail, however, the information receiver need not always connect to the communication line.

Accordingly, the cost for using the communication line can be reduced, while at the same time the information receiver can obtain the latest information automatically and assuredly.

In an alternative embodiment of the invention the information providing apparatus is configured to cause the information providing service to start and stop upon receipts of respective telephone calls from the information receiver which are used as cues for the start and stop, respectively, of the information providing service.

It should be noted that the term “e-mail” used throughout the specification means an electronic mail.

The foregoing and other objects, features and attendant advantages of the present invention will become apparent from the reading of the following detailed description with reference to the attached drawings.

### BRIEF DESCRIPTION OF THE DRAWINGS

FIG. 1 is a view illustrating an overall system configuration according to one embodiment of the present invention;

FIG. 2 is a block diagram showing the construction of each computer used in the embodiment;

FIG. 3 is a block diagram showing the functional configuration of the embodiment;

FIG. 4 is a view illustrating the memory map of a server computer used in the embodiment;

FIG. 5 is a flowchart showing the procedure for collecting information in the embodiment;

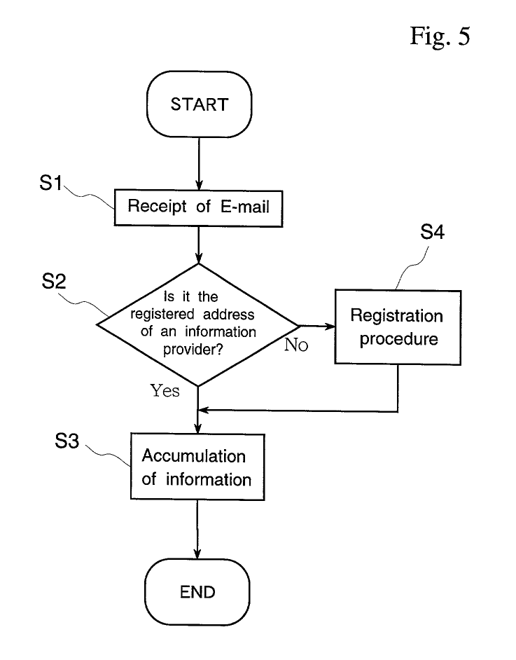

FIG. 6 is a flowchart showing the procedure of an information providing service in the embodiment;

FIG. 7 is a flowchart showing the procedure of an information providing service in another embodiment;

FIG. 8 is a block diagram showing the functional configuration of another embodiment;

FIG. 9 is a view illustrating the memory map of a server computer used in another embodiment; and

FIG. 10 is a flowchart showing the procedure of an information providing service in another embodiment.

### DETAILED DESCRIPTION OF THE PREFERRED EMBODIMENTS

The present invention will now be described in detail by way of the preferred embodiments thereof with reference to the drawings.

### 1. System Configuration

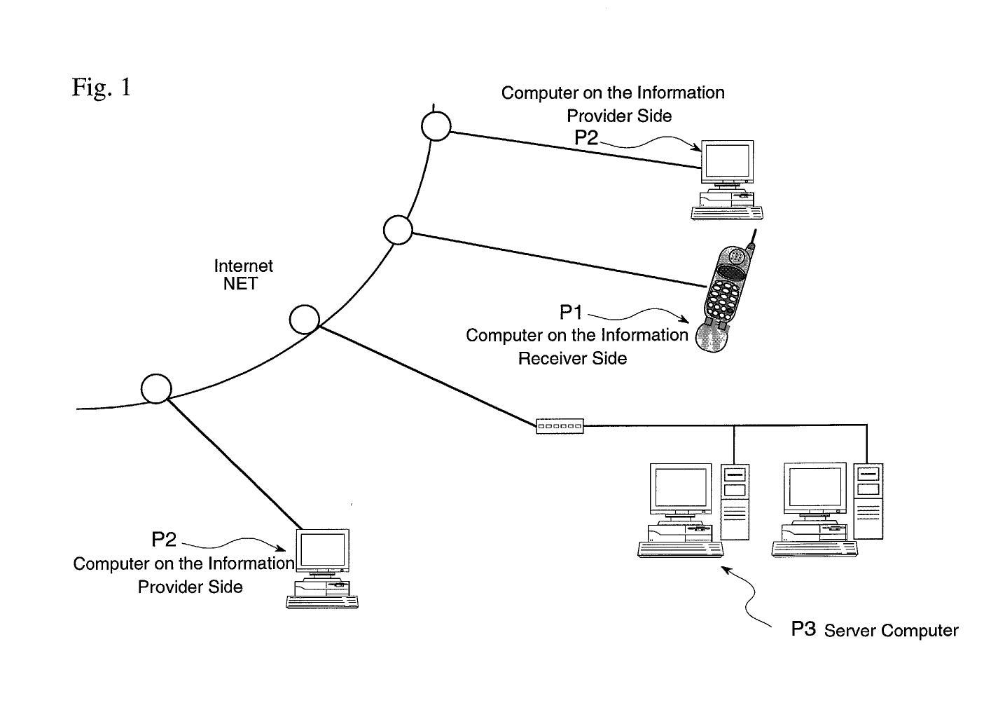

FIG. 1 illustrates an overall system configuration including a server computer P3 as an information providing apparatus according to one embodiment of the present invention. Reference character P1 designates a computer used as an information processing apparatus on the information receiver side. In this embodiment the computer P1 is an internet-accessible cellular phone comprising an input section, a display section, a CPU, memory, a communication interface, and the like. The computer P1 may be a personal computer, a so-called portable terminal, or the like. The term “information” used herein is meant to include information of the result of a game such as baseball, information of a vehicle distribution request associated with freight delivery, and like information. The term “information receiver” used herein means one who actually utilizes an information providing service.

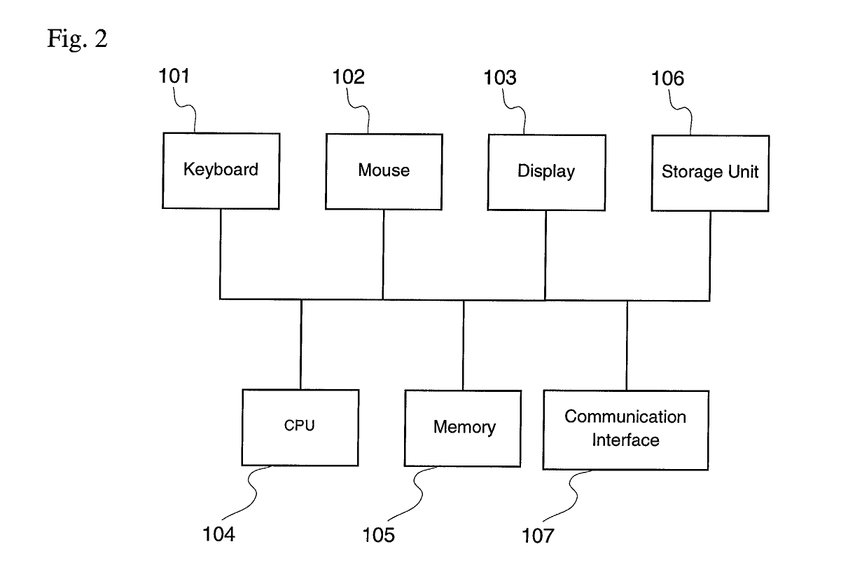

Reference numeral P2 designates a computer used as an information processing apparatus on the information provider side. The computer P2 is, for example, a so-called a personal computer connected to the internet NET. As shown in FIG. 2, the computer P2 comprises a keyboard 101, a mouse 102, a display 103, a CPU 104, internal memory 105, an external storage unit 106 such as a hard disk, a communication interface 107, and the like. The term “information provider” means one who transmits information to be given to the information receiver by the information providing service to the server computer P3 (to be described later). The administrator of this server computer P3 may also play the role of the information provider.

The server computer P3 serves as the information providing apparatus used by the server computer administrator. The server computer P3 is online with the internet NET through, for example, a path control device such as a router. The server computer P3 has a mail server function including a mail delivery function and a mail control function, a web server function, and a database function and is of substantially the same construction as the computer P2.

Thus, the system according to this embodiment utilizes the computer P1 on the information receiver side, the computer P2 on the information provider side and the server computer P3, which are connected to each other for communication via a communication network such as the internet NET.

### 2. Schematic Functional Configuration

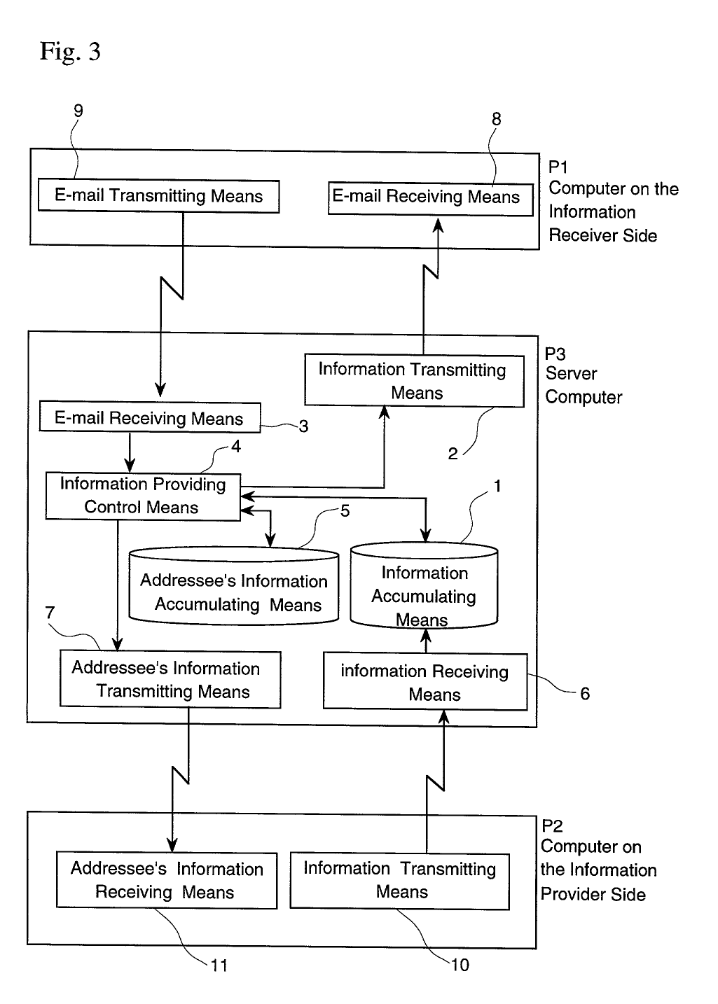

The server computer P3 in this embodiment causes the CPU 104 or peripheral devices to operate according to the programs or the like stored in its storage unit thereby to function as information accumulating means 1, information transmitting means 2, e-mail receiving means 3, an information providing control means 4, an addressee's information accumulating means 5, an information receiving means 6, and an addressee's information transmitting means 7, as shown in FIG. 3. In this embodiment the programs stored in a computer-readable recording medium such as a CD-ROM are installed in the server computer P3. Alternatively, the programs may be downloaded from a host computer storing the programs for their installation in the server computer P3.

The information accumulating means 1 serves to accumulate information to be given to the information receiver in the information providing service and is established in a predetermined area of the external storage unit. In this embodiment the information accumulated in the information accumulating means 1 is transmitted from the computer P2 on the information provider side.

The information transmitting means 2 serves to transmit the information to be provided to the computer P1 on the information receiver side in response to an instruction provided by the information providing control means 4. The information transmitting means 2 comprises the aforementioned interface. This embodiment is configured to transmit information in the form of an e-mail.

When the e-mail receiving means 3 receives an e-mail from the information receiver, the information providing control means 4 checks the e-mail address contained in the e-mail thus received against a mailing list accumulated by the addressee s information accumulating means 5 (to be described later) to judge whether or not the e-mail received is the first one from the information receiver. If the received e-mail is judged to be the first one transmitted from the information receiver, the information providing control means 4 extracts a piece of information desired by the information receiver from the information accumulating means 1 and starts providing the information providing service for the information receiver through the information transmitting means 2. On the other hand, if the received e-mail is judged to be the second one, the information providing control means 4 causes the information providing service to stop.

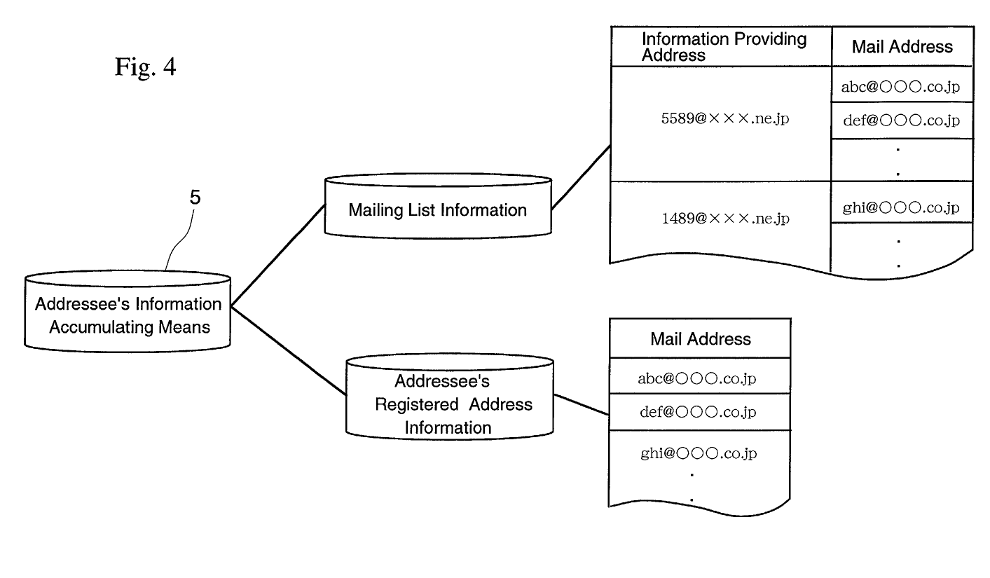

The addressee's information accumulating means 5 serves to accumulate the information of the addressee contained in the e-mail transmitted from the information receiver. In this embodiment the addressee's information accumulating means 5 accumulates mailing list information and addressee's registered address information, as shown in FIG. 4. In the mailing list information are accumulated e-mail addresses currently logging in to the information providing service as the mailing list in relation to information providing addresses. In the addressee's registered address information are accumulated all the addresses of e-mails received by the e-mail receiving means 3 even once.

The information receiving means 6 serves to receive information transmitted from the computer P2 on the information provider side and send it to the information accumulating means 1.

The addressee's information transmitting means 7 serves to transmit the addressee's information accumulated in the addressee's information accumulating means 5 to the computer P2 on the information provider side.

The computer P1 on the information receiver side causes the CPU or peripheral devices to operate according to programs or the like stored in its storage unit thereby to serve as e-mail receiving means 8 and e-mail transmitting means 9, as shown in FIG. 3.

The e-mail receiving means 8 serves to receive an e-mail containing information transmitted from the server computer P3.

The e-mail transmitting means 9 serves to transmit an e-mail to the server computer P3 in order to log in to or log off the mailing list for the information providing service to start or stop.

The computer P2 on the information provider side causes its CPU or peripheral devices to operate according to programs or the like stored in its storage unit thereby to serve as information transmitting means 10 and addressee's information receiving means 11, as shown in FIG. 3.

The information transmitting means 10 serves to transmit an e-mail containing information to be transmitted to the server computer P3. In this embodiment the e-mail is transmitted in the form of a web mail.

The addressee's information receiving means 11 serves to receive addressee's information accumulated in the addressee's information accumulating means 5 of the server computer P3.

### 3. Operation

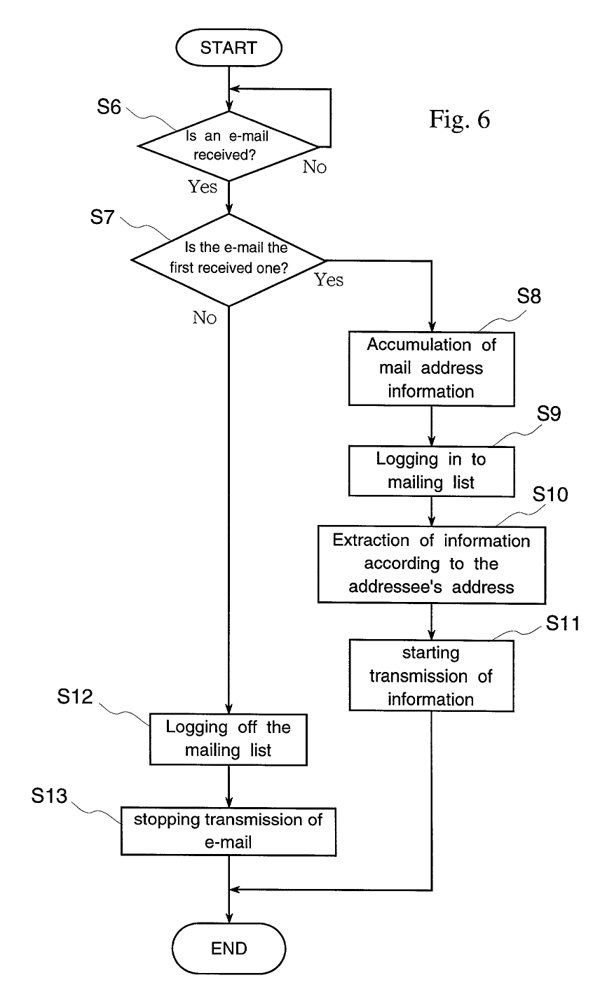

An example of the operation of the system according to this embodiment is described below with reference to FIGS. 3 and 6.

Described first is the stage at which information to be provided by the information providing service is collected from the information provider side.

Before providing information, the information provider completes registration with the server computer P3.

In registering the information provider the server computer P3 allocates a register number made related to with the content of information to be provided.

This register number itself is indicative of the content of information to be provided. For instance, if the content of information to be provided is the result of a baseball game, register number 99 (nine players vs. nine players) may be allocated.

After the allocation of the register number, the server computer P3 gives the information provider an e-mail address as an information receiving address. This address corresponds to the register number, for example, 99@xxx.com. This information receiving address is used when the information provider transmits information to the server computer P3.

At the same time therewith, an information providing address corresponding to the register number is allocated. Such an information providing address is 99@◯◯◯.com, for example. The information receiver addresses to this information providing address to receive the information providing service.

The procedure for the server computer P3 to collect information is described below with reference to FIGS. 3 and 6.

The computer P2 on the information provider side transmits information desired to provide by the information provider to the information receiving address in the form of a web mail through the information transmitting means 2.

The server computer P3 receives the e-mail from the computer P2 on the information provider side by the information receiving means 6 (step S1) and then judges whether or not the address of the transmitter has already been registered (step S2). If it has been registered, the server computer P3 accumulates the information in the information accumulating means 1 while making it correspond to the information providing address (step 3). On the other hand, if the transmitting address has not been registered yet, the server computer P3 returns a reply mail asking the information provider to complete the registration procedure (step S4).

Described next with reference to FIGS. 3, 4 and 6 is the stage at which the information providing service is actually performed.

The information providing address is known to the information receiver by previous advertisement or the like.

First, an e-mail is transmitted to the information providing address from the information receiver by the e-mail transmitting means 9 of the cellular phone serving as the computer P1 on the information receiver side for the information receiver to obtain the information providing service.

It is noted here that such an e-mail does not necessarily contain any statement.

The server computer P3 receives the e-mail containing such information such as the e-mail address of the transmitter through the e-mail receiving means 3 (step S6), and transfers the information thus received to the information providing control means 4.

The information providing control means 4, in turn, judges whether the received e-mail is the first one or the second one from that information receiver (step S7). This judgment is achieved by checking whether the e-mail address contained in the received information is listed in the mailing list accumulated in the addressee's information accumulating means 5.

If the information providing control means 4 does not find the e-mail address of the transmitter in the mailing list, the received e-mail is judged to be the first one, then the information providing control means 4 adds the e-mail address of the transmitter into the mailing list (step S8) and causes the information receiver to log in to the mailing list (step S9) thereby to cause the information providing service to start.

In the beginning of the information providing service, the information providing control means 4 extracts the information to be provided from the information accumulating means 1 using the information providing address contained in the e-mail received from the information receiver as a clue (step S10).

The information thus extracted is transmitted to the cellular phone P1 of the information receiver in the form of an e-mail through the information transmitting means 2 (step S11).

The server computer P3 continues transmitting e-mails until the cellular phone logs off the mailing list.

The cellular phone P1 of the information receiver receives the e-mail through the e-mail receiving means 8 thereby obtaining desired information. In the case where the received e-mail contains an URL as linked, the information receiver can also read the information provided on a web page by selecting or clicking the URL. It is also possible that the first e-mail transmitted to the information receiver from the server computer P3 contains a menu screen showing hyperlinked e-mail addresses leading to subdivided information providing services.

When the information receiver wishes the information providing service to stop, the information receiver transmits an e-mail to the same information providing address again from the cellular phone P1.

When the server computer P3 receives such an e-mail, the information providing control means 4 judges whether the received e-mail is the first one or the second one from the transmitting side as in the manner described above.

If the mail address of the transmitter is found in the mailing list, the e-mail is judged to be the second one and then the address of the transmitter is deleted to cause that information receiver to log off the mailing list (step S12). Then, the server computer P3 stops transmitting the e-mail to the information receiver (step S13) to stop the information providing service.

It is possible that the information providing service is stopped by causing the information receiver to log off the mailing list automatically at the time when a predetermined period has elapsed from the starting of the information providing service.

The next stage is to transmit addressee's information collected from the information receiver to the information provider if the information provider wishes to obtain such addressee's information. Specifically, the server computer P3 transmits information accumulated in the addressee's information accumulating means 5 to the information provider through the addressee's information transmitting means 7. The computer P2 on the information provider side receives such information through the addressee's information receiving means 11.

As described above, this embodiment configured to start the information providing service upon receipt of an e-mail serving as a starting cue enables the information receiver to obtain the information providing service easily without requiring the information receiver to follow the cumbersome procedures such as the registration procedure and inputting of URL, ID number, password or the like.

Further, this embodiment is configured to start and stop the information providing service upon receipts of respective cues, namely, upon receipt of the first e-mail and upon receipt of the second e-mail from the information receiver and, hence, the information providing service can be started in response to a simpler cue and can be stopped by a simpler procedure, or transmitting an e-mail. Thus, the information providing service, as a whole, can be further improved in terms of convenience.

Furthermore, since information is provided in the form of e-mail, the information receiver need not always connect to the communication line. Accordingly, the cost for using the communication line can be reduced, while at the same time the information receiver can obtain the latest information assuredly and automatically. In addition, the information receiver become capable of easy access to information provided on a web page if the web page is linked to the text of an e-mail by which information is brought to the information receiver.

In this way, the information providing service can be rendered convenient or inexpensive for the information receiver.

Further, the service provider can collect exact e-mail addresses as personal information through the server computer P3 in exchange for the information providing service.

Additionally, the cost including the fee for running the information providing menu on the cellular phone P1 or the like becomes unnecessary.

### 4. Other Embodiments

Another embodiment of the system according to the present invention is described below which is configured to facilitate communication between the information receiver and the information provider, for example, an offer of a work and an acceptance of the offer through the information providing service.

The same procedure as in the foregoing embodiment is followed in the stage at which information to be given to the information receiver by the information providing service is collected from the information provider.

The term “information provider” used in this embodiment means one who offers a work or the like or recruits a person who wishes to accept such an offer, and the term “information receiver” means one who intends to accept such an offer.

The term “information” used in this embodiment is meant to include, for example, information of a request for delivery of medical supplies. Such request information contains specific information of the request such as the kind of the freight, delivery route, and desired delivery charge, as well as information to be transmitted to a person chosen to entrust the work for the purpose of notifying the person of the request.

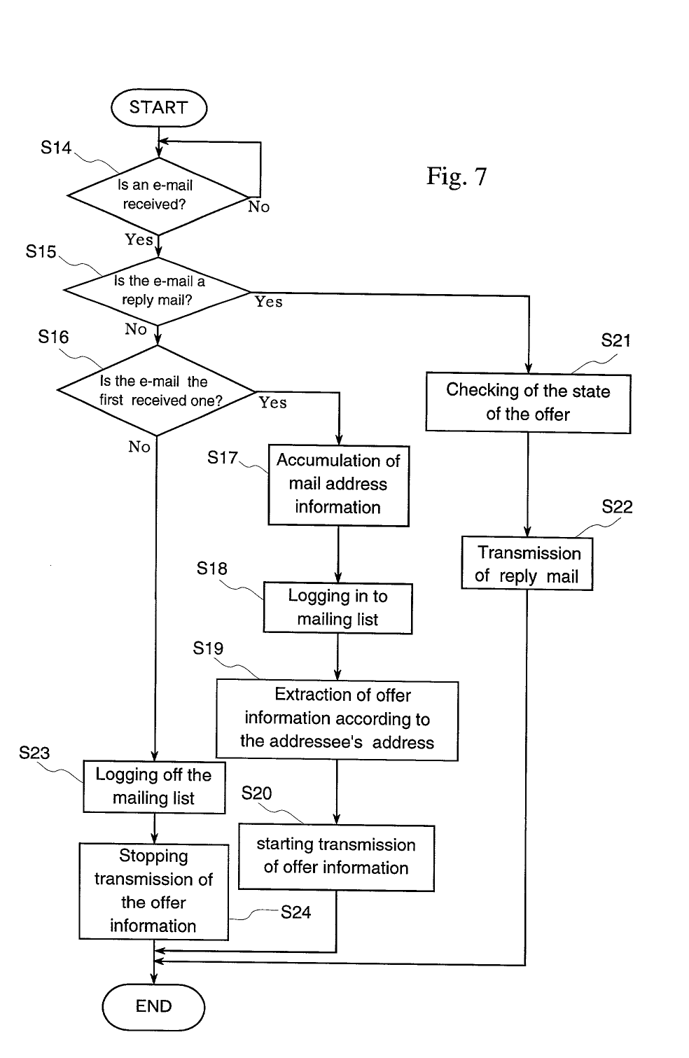

The stage at which the information providing service is performed is described below with reference to FIGS. 3, 4 and 7.

In this embodiment, the term “reply mail” means an e-mail returned to the server computer P3 in reply to an e-mail transmitted from the server computer P3 in a state made self-evident as a reply mail by using the reply mail transmitting function or the like of the cellular phone P1 on the information receiver side, and the term “ordinary e-mail” means an e-mail other than the reply mail.

First, an ordinary e-mail is transmitted to the information providing address from the information receiver by the e-mail transmitting means 9 of the cellular phone serving as the computer P1 on the information receiver side for the information receiver to obtain the information providing service.

The server computer P3 receives the e-mail thus transmitted (step S14) and then judges whether the received e-mail is an ordinary e-mail or a reply mail (step S15). If the received e-mail is judged to be the ordinary e-mail, the same procedures as in the foregoing embodiment are followed (steps S16 and S17) to cause the information receiver to log in to the mailing list (step S18), and offer information to be provided is extracted (step S19) and then transmitted to the cellular phone P1 on the information receiver side (step S20).

If the information receiver wishes to accept the offer of a work contained in the offer information, the cellular phone P1 transmits to the server computer P3 an e-mail containing information that this e-mail is a reply mail.

If the information providing control means 4 judges the received e-mail to be the reply mail, the information providing control means 4 accesses the information accumulating means 1 to check whether the recruit for the work has ended or not (step S21).

If the recruit has not ended yet, the server computer P3 transmits an offer mail of the information provider to the information receiver, while, on the other hand, if the recruit has already ended, the server computer P3 transmits a mail of apology stating that the recruit for the work has already ended to the cellular phone P1 on the information receiver side (step S22).

In turn, when the information receiver wishes the information providing service to stop, an ordinary e-mail is transmitted to the information providing address again from the cellular phone P1 of the information receiver. Upon receipt of this e-mail, the information receiver is caused to log off the mailing list (step S23). Thus, the information providing service is stopped (step S24).

Since this embodiment is configured to achieve the information providing service for providing information containing an offer of a work which can be accepted expressly by the information receiver, the embodiment has an advantage that information to be handled can be diversified as well as advantages similar to those of the foregoing embodiment. In addition, since the expression of the information receiver's acceptance of the offer is made by simply returning an e-mail, the information providing service becomes still more convenient.

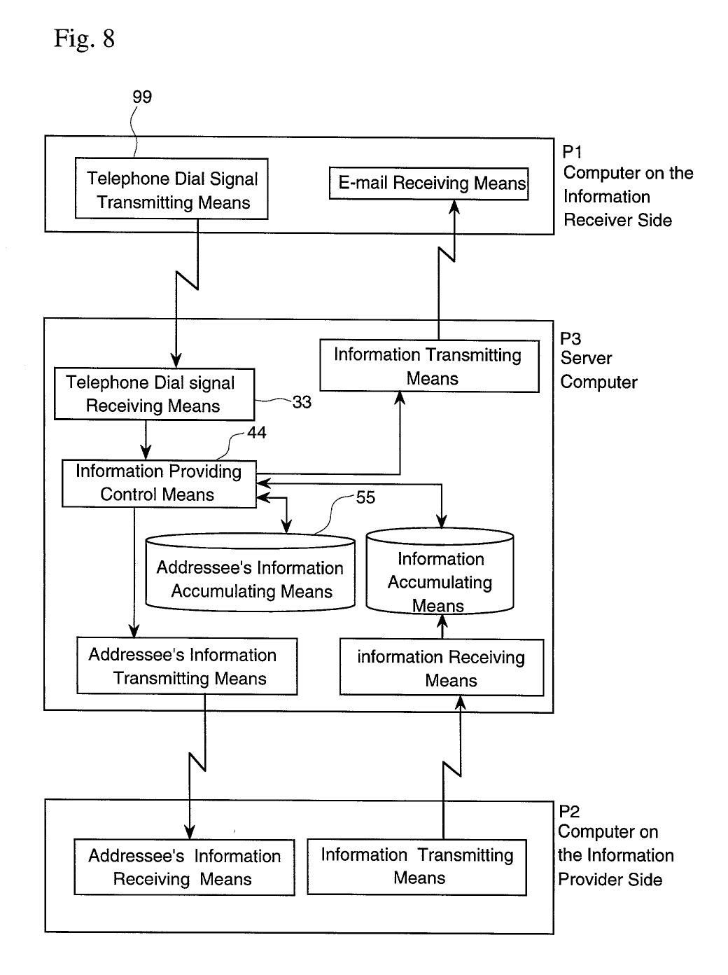

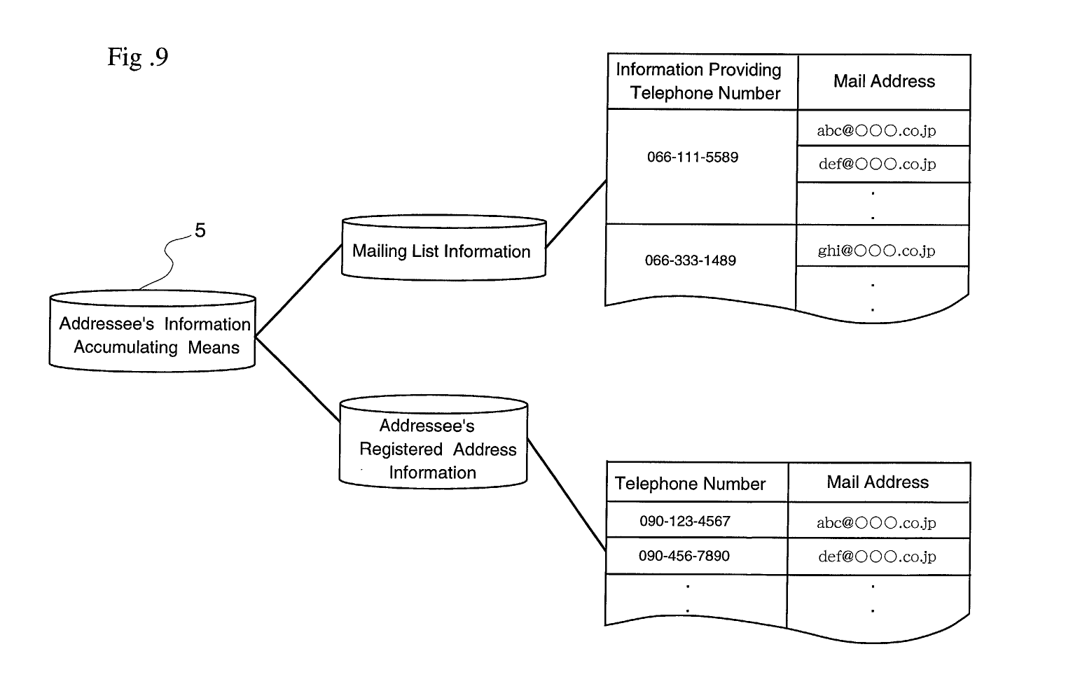

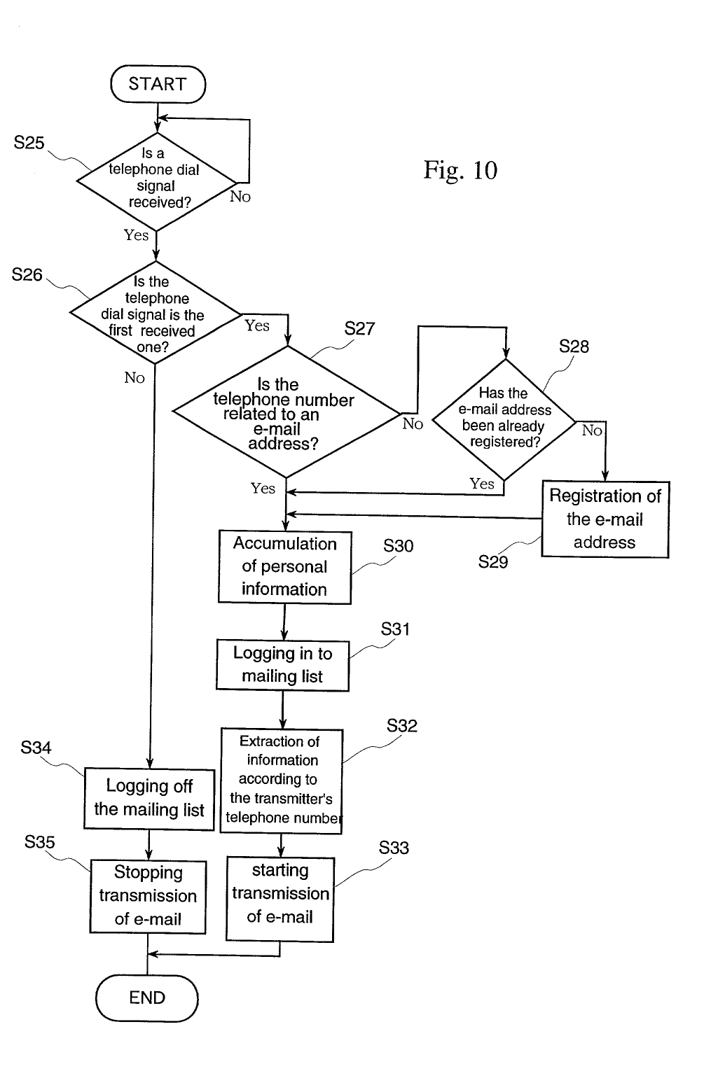

With reference to FIGS. 8, 9 and 10, an embodiment configured to cause the information receiver to log in to and log off the mailing list upon respective receipts of a telephone dial signal is described below.

The same procedure as in the foregoing embodiment is followed in the stage at which the server computer P3 collects information.

The stage at which the information providing service is performed is as follows.

In this embodiment the server computer P3 establishes an information providing telephone number corresponding to a register number instead of the foregoing information providing address.

The information providing telephone number is known to the information receiver by previous advertisement or the like.

First, the information receiver transmits a telephone dial signal corresponding to the information providing telephone number through a telephone dial signal transmitting means 99 of a cellular phone serving as the computer P1 on the information receiver side for the information receiver to obtain the information providing service.

It is noted here that such a telephone call need not necessarily be connected so long as the server computer P3 receives the telephone dial signal.

The server computer P3 receives the dial signal containing such information as the telephone number of the transmitter through telephone dial signal receiving means 33 (step S25) and transfers the information thus received to information providing control means 44.

The information providing control means 44, in turn, judges whether the receipt of the telephone call is the first one or not from that information receiver (step S26).

If the receipt of the telephone call is judged to be the first one, then the information providing control means 44 judges whether or not the telephone number contained in such received information is related to the e-mail address of the addressee to which information is to be given (step S27).

Specifically, such judgment is made from the cellular phone company with which the information receiver on the transmitting side has a subscriber contract. If such a cellular phone company is the NTT DoCoMo, the e-mail address of the information receiver can be determined by adding @docomo.ne.jp after the telephone number of the information receiver. In this case, the telephone number is judged as related to the addressee's e-mail address. However, there is such a case where some telephone companies do not make the telephone number related to the e-mail address or the information receiver have changed the e-mail address into one not related to the telephone number. In such a case the telephone number is judged to have no relation to the e-mail address.

If the information providing control means 44 judges the telephone number to be related to the e-mail address, the e-mail address determined by the telephone number is accumulated in addressee's information accumulating means 55 (step S30).

Alternatively, if the telephone number is judged to have no relation to the e-mail address, then the information providing control means 44 judges whether or not the addressee's e-mail address of the information receiver has been registered in the addressee's information accumulating means 55 (step S28).

Subsequently, if the e-mail address is judged to have not been registered, a telephone call to the telephone number contained in the received information is made to urge the information receiver to follow the registration procedure (step S29). Even if there is not such a return phone call, the information receiver may follow the registration procedure for obtaining the information providing service.

A specific registration procedure is to register the addressee's e-mail address of the information receiver by facsimile or telephone or through internet. The server computer P3 accumulates the addressee's e-mail address that identifies such an information receiver in the addressee's information accumulating means (step S30). If the information receiver wishes settlement on credit during the period for which the information receiver utilizes the information providing service, credit information of the information receiver is additionally required in the registration procedure and accumulated in the addressee's information accumulating means 55.

In the case where the addressee's e-mail address is related to the telephone number of the information receiver or the e-mail address of the information receiver can be specified by referencing the registered addressee's e-mail address, the information receiver is caused to log in to the mailing list as in the foregoing embodiment (step S31), and information to be given to the information receiver is extracted (step S32). Thus, the information providing service is started. It should be noted that the server computer P3 starts the information providing service after lapse of a predetermined time period from the receipt of the dial signal (step S33), taking the time to required by the information receiver in transmitting and receiving telephone calls.

If the receipt of the telephone dial signal is judged to be the second receipt from the information receiver, the server computer P3 causes the information receiver to log off the mailing list (step S34) and stops the information providing service (step S35).

This embodiment, which is configured to start the information providing service upon receipt of a telephone call serving as a starting cue, has an advantage that the cue for the start of the information providing service can be diversified while the information providing service is made more convenient, as well as advantages similar to those of the foregoing embodiments.

In addition, the information receiver can save the effort to input the e-mail address of the information provider. Further, the information receiver can obtain the information providing service more conveniently through an easy operation consisting of simply giving a telephone call even if the information receiver is unfamiliar with transmission or receipt of e-mails. Furthermore, the information provider on the server computer P3 side may wish to collect telephone numbers instead of e-mail addresses in exchange for the information providing service.

Another embodiment may be configured such that the information providing control means 44 causes the information receiver to log in to the mailing list upon receipt of an e-mail and to log off the mailing list upon receipt of a telephone dial signal, or conversely, the information providing control means 44 causes the information receiver to log in to the mailing list upon receipt of a telephone dial signal and to log off the mailing list upon receipt of an e-mail.

Such an embodiment allows the information receiver to utilize the information providing service more conveniently.

The invention is not limited to the above-described embodiment.

For example, the above-described embodiment is configured that the server computer P3 directly receives the e-mail or the telephone dial signal from the computer P1 on the information receiver side, which serves as cue for the start of the information providing service, but the computer P2 on the information provider side may receive the e-mail or the telephone dial signal from the computer P1 on the information receiver side. The e-mail address or the telephone number of the computer P1 on the information receiver side is then transmitted from the computer P2 on the information provider side to the server computer P3 by e-mail. The server computer P3 starts the information providing service upon receipt of the e-mail from the computer P2 on the information provider side. In this case, the server computer P3 identifies the e-mail address of the addressee to which information is to be given from the received e-mail containing the e-mail address or the telephone number of the computer P1 on the information receiver side by making use of the aforementioned information providing control means 4, 44 or the addressee's information accumulating means 5, 55. Then information is transmitted to the computer P1 on the information receiver side in the form of an e-mail.

In addition, in the above-described embodiment the information to be provided to the computer P1 on the information receiver once the information providing service starts is extracted from the information accumulated in the information accumulating means 1 of the server computer P3. The information may be obtained from information on a web page located at a URL which is transmitted from the computer P2 on the information provider side by e-mail, thereby to start the information providing service.

More specifically, as the computer P2 on the information provider side receives an e-mail or a telephone dial signal from the computer P1 on the information receiver side, it transmits an e-mail containing such information as the e-mail address or the telephone number of the computer P1 on the information receiver side to the server computer P3. The e-mail transmitted to the server computer P3 also contains a URL of a web page which carries information that the information provider wishes to provide to the computer P1 on the information receiver side. The server computer P3 receives the e-mail from the computer P2 on the information provider side and obtains information from the web page by making access to the web page located at the URL contained in the received e-mail through an access means consisting of a communication interface or the like. The information thus obtained may be converted into a text form and transmitted to the computer P1 on the information receiver side by e-mail or the like, thereby to conduct the information providing service.

Further, in the above-described embodiment the information providing service for the information receiver is carried out by transmitting information in the form of an e-mail to the computer P1 on the information receiver side, but the information may be transmitted to the information receiver via facsimile.

More specifically, a facsimile number of the addressee to which information is to be given is related to an e-mail address or a telephone number of the information receiver and then accumulated in the addressee's information accumulating means 5. The information providing service is started upon receipt of an e-mail or a telephone dial signal from the information receiver, by transmitting information to the addressee's facsimile number related to the e-mail address or the telephone number of the information receiver. It should be noted that the addressee's facsimile number may be registered beforehand by facsimile or telephone or through internet, or it may be notified by an e-mail or a telephone call from the information receiver which serves as the cue for the start of the information providing service.

Moreover, a printer may be connected to the computer P1 on the information receiver side to print out contents of the information to be provided in response to a command transmitted from the server computer P3 by e-mail, thereby to start the information providing service. In other words, there is no necessity for the information receiver to operate the printer to enjoy the information providing service since the printer on the information receiver side automatically prints out the contents of the information by receiving the e-mail from the server computer P3 through the computer P1 on the information receiver side.

The present invention thus embodied into the configurations described above possesses the following advantages.

The embodiment of the present invention that is configured to start the information providing service upon receipt of an e-mail as a starting cue enables the information receiver to obtain the information providing service easily without requiring the information receiver to follow any cumbersome procedure such as the registration procedure and inputting of URL, ID number, password or the like. In addition, the cost including the fee for running the information providing menu is no more necessary.

On the other hand, the information provider can collect exact e-mail addresses as personal information in exchange for the information providing service.

Further, the embodiment that is configured to start the information providing service upon receipt of a telephone call as a starting cue, has an advantage that the cue for the start of the information providing service can be diversified and, hence, the information providing service is made more convenient.

In addition, the information receiver can save the effort to input the e-mail address of the information provider. Further, the information receiver can obtain the information providing service more conveniently through an easy operation consisting of simply giving a telephone call even if the information receiver is unfamiliar with transmission or receipt of e-mails. Furthermore, the information provider may wish to collect telephone numbers instead of e-mail addresses in exchange for the information providing service.

Further, the embodiment that is configured to start and stop the information providing service upon receipts of e-mail from the information receiver which are used as respective cues, allows the information providing service to start in response to a simpler cue and to stop by a simpler procedure consisting of simply transmitting an e-mail. Thus, the information providing service, as a whole, can be further improved in terms of convenience.

Furthermore, since information is provided in the form of e-mail, the information receiver need not always connect to the communication line. Accordingly, the cost for using the communication line can be reduced, while at the same time the information receiver can obtain the latest information assuredly and automatically.

Thus, the information providing service can be rendered convenient or inexpensive for the information receiver.

While only certain presently preferred embodiments of the present invention have been described in detail, as will be apparent for those skilled in the art, certain changes and modifications may be made in embodiment without departing from the scope of the present invention as defined by the following claims.

What is claimed is:

1. An information providing apparatus for providing an information receiver with an information providing service, comprising:
information accumulating means for accumulating information to be provided;
electronic mail receiving means for receiving an electronic mail; and
information providing control means for extracting desired information from the information accumulating means to start the information providing service for the information receiver having transmitted an electronic mail to an electronic mail address by which the information to be provided by the information providing service is identified or given a telephone call to a telephone number by which the information to be provided by the information providing service is identified upon receipt of the electronic mail by the electronic mail receiving means.

2. An information providing apparatus for providing an information receiver with an information providing service, comprising:
access means for accessing information on a web page located at a URL transmitted from an information provider;
electronic mail receiving means for receiving an electronic mail; and
information providing control means for obtaining the information accessed by the access means to start the information providing service for the information receiver having transmitted an electronic mail to an electronic mail address by which the information to be provided by the information providing service is identified or given a telephone call to a telephone number by which the information to be provided by the information providing service is identified upon receipt of the electronic mail by the electronic mail receiving means.

3. An information providing apparatus for providing an information receiver with an information providing service, comprising:
information accumulating means for accumulating information to be provided;
electronic mail receiving means for receiving an electronic mail; and
information providing control means for extracting desired information from the information accumulating means to start the information providing service for the information receiver having transmitted the electronic mail upon receipt of the electronic mail by the electronic mail receiving means.

4. An information providing apparatus for providing an information receiver with an information providing service, comprising:
information accumulating means for accumulating information to be provided;
telephone dial signal receiving means for receiving a telephone dial signal; and
information providing control means for extracting desired information from the information accumulating means to start the information providing service for the information receiver having transmitted the telephone dial signal upon receipt of the telephone dial signal by the telephone dial signal receiving means.

5. An information providing apparatus for providing an information receiver with an information providing service, comprising:
information accumulating means for accumulating information to be provided;
electronic mail receiving means for receiving an electronic mail; and
information providing control means for identifying the information receiver having transmitted the electronic mail by an electronic mail address contained in the electronic mail and extracting desired information from the information accumulating means to start the information providing service for the information receiver upon receipt of the electronic mail by the electronic mail receiving means and for causing the information providing service for the information receiver to stop upon receipt of a second electronic mail from the information receiver by the electronic mail receiving means.

6. An information providing apparatus for providing an information receiver with an information providing service, comprising:
information accumulating means for accumulating information to be provided;
telephone dial signal receiving means for receiving a telephone dial signal; and
information providing control means for identifying the information receiver having transmitted the telephone dial signal by the telephone dial signal and extracting desired information from the information accumulating means to start the information providing service for the information receiver upon receipt of the telephone dial signal by the telephone dial signal receiving means and for causing the information providing service for the information receiver to stop upon receipt of a second telephone dial signal from the information receiver by the telephone dial signal receiving means.

7. An information processing apparatus comprising electronic mail transmitting means for allowing an information receiver to transmit an electronic mail to electronic mail receiving means provided in an information providing apparatus as recited in claim 1.

8. An information processing apparatus comprising telephone dial signal transmitting means for allowing an information receiver to transmit a telephone dial signal to telephone dial signal receiving means provided in an information providing apparatus as recited in claim 2.

9. An information processing apparatus comprising information transmitting means which transmits information to be accumulated by information accumulating means provided in an information providing apparatus as recited in claim 1 or 4 or a URL of a web page carrying information desired to be provided by the information providing service.

10. A recording medium for use in providing an information receiver with an information providing service, comprising, as stored therein, a program for realizing the information providing service by using:
information accumulating means for accumulating information to be provided;
electronic mail receiving means for receiving an electronic mail; and
information providing control means for extracting desired information from the information accumulating means to start the information providing service for the information receiver having transmitted an electronic mail to an electronic mail address by which the information to be provided by the information providing service is identified or given a telephone call to a telephone number by which the information to be provided by the information providing service is identified upon receipt of the electronic mail by the electronic mail receiving means.

11. A recording medium for use in providing an information receiver with an information providing service, comprising, as stored therein, a program for realizing the information providing service by using:
access means for accessing information on a web page located at a URL transmitted from an information provider;
electronic mail receiving means for receiving an electronic mail; and
information providing control means for obtaining the information accessed by the access means to start the information providing service for the information receiver having transmitted an electronic mail to an electronic mail address by which the information to be provided by the information providing service is identified or given a telephone call to a telephone number by which the information to be provided by the information providing service is identified upon receipt of the electronic mail by the electronic mail receiving means.

12. A recording medium for use in providing an information receiver with an information providing service, comprising, as stored therein, a program for realizing the information providing service by using:
information accumulating means for accumulating information to be provided;
electronic mail receiving means for receiving an electronic mail; and
information providing control means for extracting desired information from the information accumulating means to start the information providing service for the information receiver having transmitted the electronic mail upon receipt of the electronic mail by the electronic mail receiving means.

13. A recording medium for use in providing an information receiver with an information providing service, comprising, as stored therein, a program for realizing the information providing service by using:
information accumulating means for accumulating information to be provided;
telephone dial signal receiving means for receiving a telephone dial signal; and
information providing control means for extracting desired information from the information accumulating means to start the information providing service for the information receiver having transmitted the telephone dial signal upon receipt of the telephone dial signal by the telephone dial signal receiving means.
